(19) United States
(12) Patent Application Publication
(10) Pub. No.: US 2002/0185326 A1
(43) Pub. Date: Dec. 12, 2002

(54) Swing arm for all terrain vehicle

(76) Inventor: Daniel Mercier, Longueuil (CA)

Correspondence Address: PILLSBURY WINTHROP, LLP, P.O. BOX 10500, MCLEAN, VA, 22102, US

(21) Appl. No.: 10/143,857

(22) Filed: May 14, 2002

Related U.S. Application Data
(60) Provisional application No. 60/290,354, filed on May 14, 2001.

(51) Int. Cl. B62D 21/00

(52) U.S. Cl. 180/311

(57) ABSTRACT

An all terrain vehicle frame includes an upper member, a lower member, a forward cross member and a rearward cross member defining a central opening. An engine is disposed in the central opening and is attached to the frame. A swing arm for supporting a shaft member of outboard wheel assemblies is pivotally attached to the frame and the engine. The swing arm has a tapered shape that increases in width from a second end including a shaft support member to a first end including two bifurcated end portions and a frame accommodating portion. Each of the two bifurcated end portions includes a journal that is rotatably supported by a transverse member that passes through the journals, the frame and the engine. The journals are provided on opposite sides of the central opening. A dampener is connected between the engine and the swing arm to reduce vibrations transmitted from the engine to the frame.

### CROSS REFERENCE TO RELATED APPLICATIONS

This application claims priority to U.S. application Ser. No. 60/290,354, filed May 14, 2001. This application is related to U.S. Non-Provisional application Ser. No. 09/824,878, filed Apr. 4, 2001, the contents of which are hereby incorporated by reference. This application is also related to U.S. Non-Provisional application Ser. No. 09/804,061, filed Mar. 13, 2001, the contents of which are hereby incorporated by reference. This application is also related to U.S. Provisional Application Serial No. 60/189,053, filed Mar. 14, 2000, the contents of which are hereby incorporated by reference. Finally, this application is related to U.S. Provisional Application Serial No. 60/188,697, filed Mar. 13, 2000, the contents of which are hereby incorporated by reference.

### BACKGROUND OF THE INVENTION

1. Field of the Invention

The present invention relates to all terrain vehicles. More particularly, the present invention relates to frames and swing arms for all terrain vehicles.

2. Description of the Related Art

All terrain vehicles are typically used on rough, uneven terrain. As all terrain vehicles include outboard wheels laterally spaced from a frame, the frame is subjected to high torsional and bending loads as the outboard wheels traverse the terrain. All terrain vehicle frames require high torsional and bending strengths, which generally require that the frame have a measure of elasticity. However, the frame must also have a measure of rigidity so as not to damage components of the vehicle and maintain good dynamic vehicle behavior. Therefore, the strength of the frame, which requires elasticity, must be balanced with the rigidity of the frame.

U.S. Pat. No. 5,855,250 to Nishi discloses a frame for an all terrain vehicle that is a typical “space” frame including laterally spaced upper, lower, front and seat frames formed of tubular members that are joined together by brackets and welds. A pair of front and rear arm brackets for supporting swing arms extend between and are integrally joined to the lower frames. The front and rear arm brackets are assembled and joined to each other before being joined to the lower frames. An engine mount component is fixed to rear portions of the lower frames.

The frame of U.S. Pat. No. 5,855,250 requires the use of a positioning table including a plurality of setting jigs to ensure accurate positioning of the upper, lower, front and seat frames and the arm brackets prior to welding the components together. The swing arms are also connected to the arm brackets only and the entire torsional and bending stresses on the swing arms are directed to the arm brackets. The welds that attach the arm bracket to the lower frames must therefore be strong enough to withstand the maximum torsional and bending stresses that the swing arms will be subjected to. The torsional and bending stresses are also transmitted through the arm brackets directly to the frame which requires that the other welds of the frame be made stronger.

U.S. Pat. No. 5,330,028 to Handa et al. discloses a straddle-riding type vehicle including laterally spaced main pipes, front pipes, reinforcing pipes, lower pipes, center pipes and seat rail pipes joined together by cross pipes and cross plates welded to the main, front, reinforcing, lower, center and seat rail pipes. Two sets of laterally spaced brackets are provided on the main pipes for suspending the engine. One set of the laterally spaced brackets extends from the main pipes and are connected to a cross pipe laterally extending between and connected to the center pipes. A pair of brackets for pivotably supporting a rear fork is laterally spaced outward of the one set of laterally spaced engine brackets. The end of the rear fork is supported on the pair of brackets by a pivot and is supported between the pair of brackets and the one set of engine brackets.

The frame of U.S. Pat. No. 5,330,028 has drawbacks similar to those discussed above with respect to U.S. Pat. No. 5,855,250. The space frame require a large number of welds to connect the laterally extending pipes and cross pipes and plates, which increases manufacturing time and expense. The brackets for pivotably supporting the rear fork must be accurately positioned to ensure that the rear fork is correctly mounted to the frame and as the rear fork is pivotably supported solely by the brackets, the welds that connect the brackets to the pipes must be strong enough to withstand the maximum torsional and bending stresses. In addition, the pivots that support the end of the rear fork are spaced laterally inward of the center pipes which requires that the end of the rear fork have a reduced width, and reduced strength, to fit between the center pipes.

U.S. Pat. No. 5,107,952 to Matsubayashi et al. discloses a straddle type off-road vehicle having a conventional space frame having a rear swing arm assembly pivotably connected to upwardly extending members spaced inside laterally opposed rear sections of the frame. The rear sections are generally looped shaped when viewed from the side of the vehicle and define a substantially continuous curve to provide a high strength and rigidity to the frame. The engine, however, is mounted to the frame separately from the rear swing arm assembly and the entire torsional and bending stress is distributed to the frame through the upwardly extending members.

U.S. Pat. No. 4,735,275 to Tsukahara et al. discloses a body frame for vehicles left and right subframes connected together by independent cross members and cross plates. Three sets of laterally opposed brackets are provided on the subframes for supporting the engine. A rear swing arm assembly is pivotably connected to the frame separately from the engine.

U.S. Pat. No. 6,024,185 to Okada et al. discloses a body structure of a motorcycle including a main frame and a sub-frame integrally connected to a rear plate. An engine is suspended downwardly by engine hangers provided on the sub-frame and the rear plate. Engine side fastening portions are formed on a crankcase of the engine at positions corresponding to the engine hangers. A rear swing arm is turnably mounted on a pivot shaft provided on a rear end side of the crankcase at a position lower than a rear engine hanger of the rear plate.

The rear swing arm of U.S. Pat. No. 6,024,185 is subject to much less torsional and bending stresses as it does not support outboard wheels. The pivot shaft is also provided on the engine crankcase at a position separate from the engine hangers of the frame so that the engine and the rear swing arm do not share a common connection point to the frame.

U.S. Pat. No. 6,189,638 to Ito et al. discloses a rear fork attachment structure for a motorcycle including left and right arm pivotally connected to a portion of a crankcase of an engine. U.S. Pat. No. 6,189,638 discloses that the rear fork is attached to the frame of the motorcycle and the crankcase of the engine at positions inward of the frame.

As described above, frames for all terrain vehicles are complex, costly, and time consuming to manufacture. Swing arms for supporting axles or shaft members of outboard wheel assemblies are also mounted to the frame separately from the engine. Separately mounting the engine and the swing arm to the frame requires accurate positioning of the brackets that pivotably support the swing arms and increases the weld strength required for the frame to be able to withstand the maximum torsional and bending stresses. As such there exists a need for an all terrain vehicle frame and swing arm that are less complex, time consuming and costly to manufacture and that are better able to withstand the torsional and bending stresses the frame and swing arm are subjected to.

### SUMMARY OF THE INVENTION

One aspect of the present invention is to provide a swing arm for supporting a shaft or axle member of an all terrain vehicle, wherein the swing arm is connected to a frame of the all terrain vehicle, an engine of the all terrain vehicle, or to the frame and the engine of the all terrain vehicle.

It is another aspect of the present invention to provide a swing arm for an all terrain vehicle that includes two journals on a first end, the two journals being spaced on opposite sides of a central opening of the frame in which the engine is disposed.

It is still another aspect of the invention to provide a swing arm for an all terrain vehicle that has a first end having two bifurcated end portions and a journal provided at each bifurcated end portion, and a second end having an axle support member, wherein the swing arm is tapered such that the first end has a greater width than the second end.

Another aspect of the present invention is to provide an all terrain vehicle including a frame including a plurality of members defining a central opening, an engine attached to the frame and disposed in the central opening, and a swing arm pivotably attached to the frame and the engine.

Still another aspect of the present invention is to provide an all terrain vehicle including a swing arm having a first end including two end portions with a space therebetween and a second end including a axle support member, wherein at least a portion of the frame is disposed in the space between the two end portions.

Yet another aspect of the present invention is to provide an all terrain vehicle including a transverse member that connects a rear swing arm to a frame of the all terrain vehicle and extends through the engine, webs connected to the frame, and journals provided on the two end portions of the swing arm.

Still another aspect of the present invention is to provide an all terrain vehicle including a frame having a central opening and an engine disposed in the central opening, the vehicle also including a swing arm having a first end including two end portions with a space therebetween and a second end including an axle support member, wherein at least a portion of the engine is disposed in the space between the two end portions.

Yet another aspect of the present invention is provide an all terrain vehicle including frame having a plurality of members defining a central opening, an engine attached to the frame and disposed in the central opening, a swing arm pivotably attached to the frame and the engine, and a dampener connected between the engine and the frame that reduces vibrations transmitted from the engine to the frame.

### BRIEF DESCRIPTION OF THE DRAWINGS

Various exemplary embodiments of the present invention will be described with reference to the following drawings, in which like reference characters represent like features, wherein:

FIG. 1 is a perspective view of an exemplary embodiment of a frame for an all terrain vehicle according to the present invention;

FIGS. 2-4 are perspective views of the frame of FIG. 1 with various vehicle components positioned relative thereto;

FIG. 5 is a perspective view of an exemplary swing arm and engine mounting arrangement according to the present invention;

FIG. 6a is a top sectional view of the swing arm and engine mounting arrangement of FIG. 5;

FIG. 6b is a top sectional view of the swing arm and engine mounting arrangement including a dampener according to the present invention;

FIG. 6c is a top sectional view of the swing arm and engine mounting arrangement including a dampener according to another embodiment of the present invention

FIG. 7 is a side view of an exemplary all terrain vehicle according to the present invention.

### DETAILED DESCRIPTION OF EXEMPLARY EMBODIMENTS

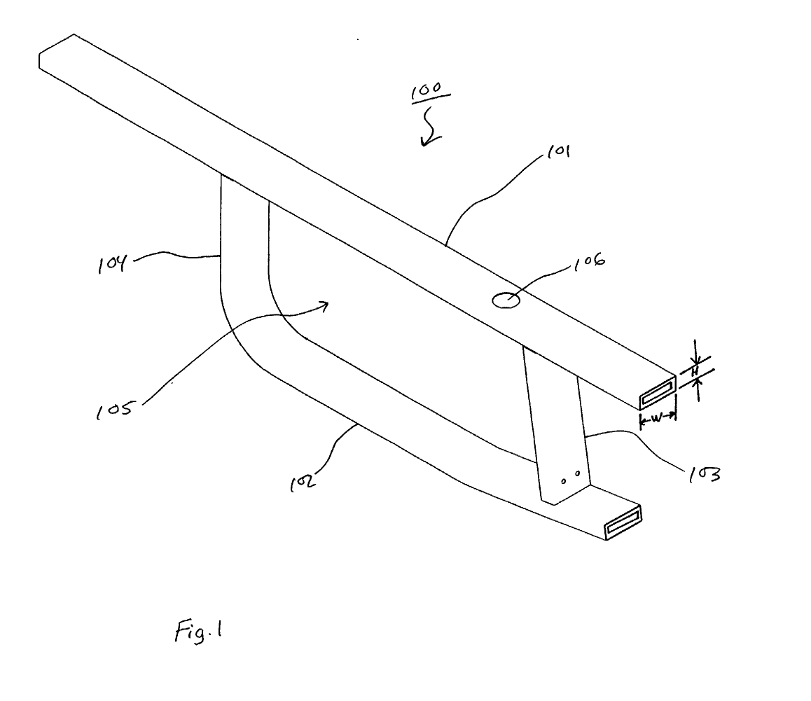

Referring to FIG. 1, an exemplary all terrain vehicle frame 100 according to the invention includes an upper member 101, a lower member 102, a forward cross member 103 and a rearward cross member 104. The upper member 101 includes an opening 106 for a steering column (described later). Although the rearward cross member 104 is shown in FIG. 1 as being integral with the lower member 102, it should be appreciated that the rearward cross member 104 may be formed separately from the lower member 102. The upper member 101, the lower member 102, the forward cross member 103 and the rearward cross member 104 are joined together, for example by welding, to define the vehicle frame 100 and to define a central opening 105 that provides an engine receiving space.

As shown in FIG. 1, members 101, 102, 103 and 104 have a rectangular tubular cross section such that a width to height ratio (W/H) is greater than 1. Although the members 101, 102, 103 and 104 are shown in FIG. 1 as having a rectangular tubular configuration, it should be appreciated that other polygonal cross sectional configurations, or oval or elliptical cross sectional configurations, that have an elongated cross sectional configuration (width to height ration greater than 1) may be used. Other aspects of the frame are described in U.S. application Ser. No. 09/824,878, incorporated herein by reference.

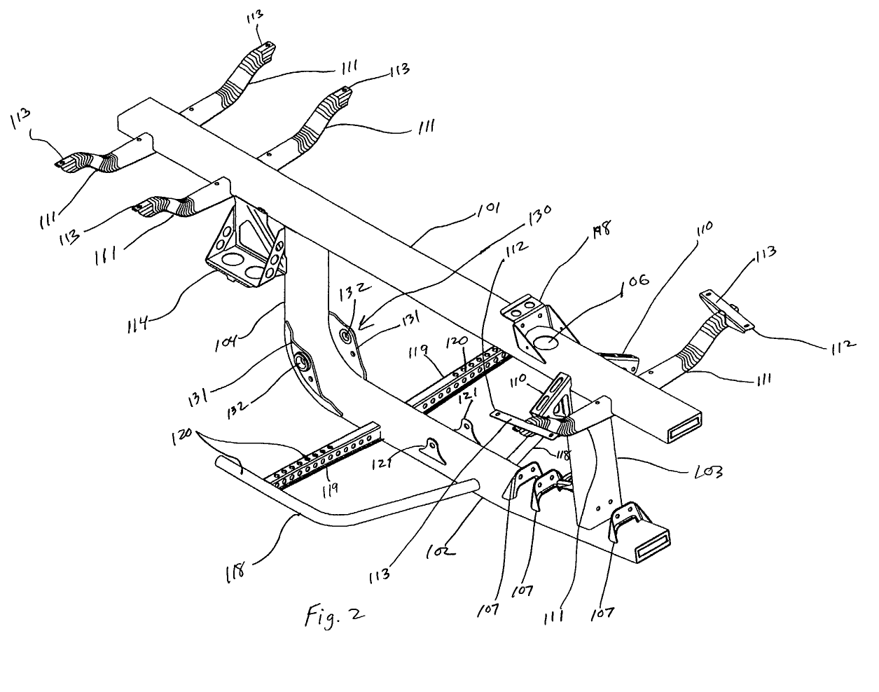

Referring to FIGS. 2-4, front suspension connecting members 107 are attached to the lower member 102, such as by welding, for connection to front suspension members 108. Biasing member connecting members 110 are connected to the upper member 101 and biasing members (not shown), such as shock absorbers and/or coil springs, are connected between the connecting members 110 and the suspension members 108. The front suspension shown in FIGS. 2-4 is of the fully independent type. It should be appreciated that other types of suspensions, such as dual A-arm suspensions or other independent and non-independent suspensions, may be adapted for use on the frame 100.

A plurality of body mounting members 111 are attached to the upper member 101 and extend laterally outwardly from the upper member 101. The body mounting members 111 provide upwardly facing body mounting surfaces 113 thereon. The body mounting members 111 may also include flange members 112 that provide the upwardly facing mounting surfaces 113 thereon. A support module 114 is connected between the rearward cross member 104 and a pair of body mounting members 111 connected to a rear portion of the upper member 101.

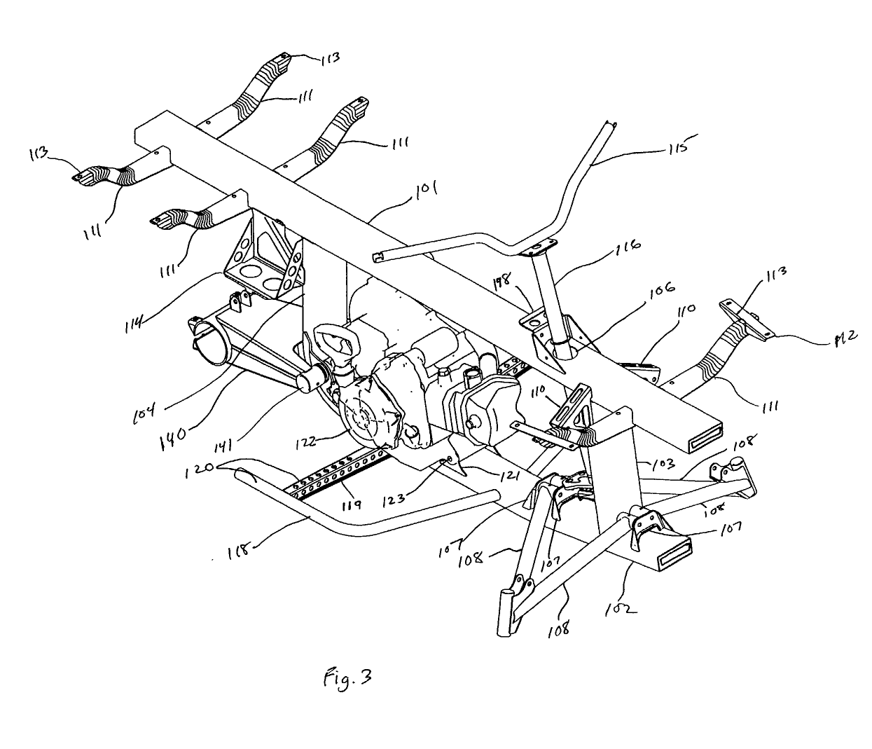

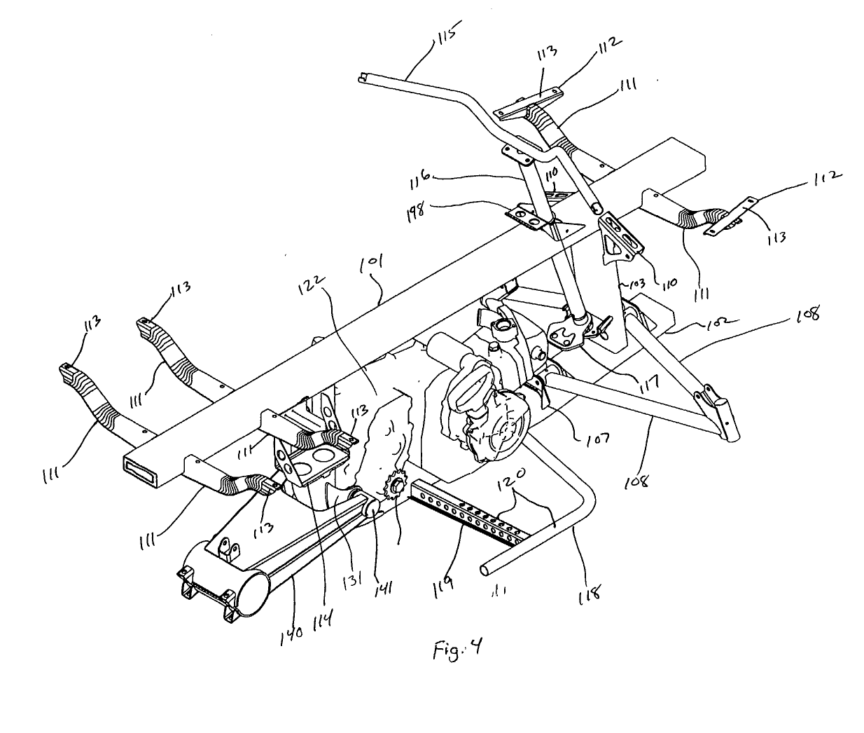

A steering member 115 (FIG. 3) is connected to a steering column 116 that passes through the opening 106 in the upper member 101. A steering column support member 198 supports the steering column 116 spaced from the periphery of the opening 106. The bottom of the steering column 116 is connected to a steering control structure 117 (FIG. 4) mounted to the forward cross member 103. The steering control structure 117 is connected to members (not shown) that are connected to wheel assemblies (not shown) supported by the suspension members 108 so that upon rotational movement of the steering column 116 by the steering member 115, the wheel assemblies will pivot an amount corresponding to the rotation of the steering column 116.

A pair of laterally outwardly extending support structures 118 and 119 for a rider's feet are mounted to the lower member 102 between the forward cross member 103 and the rearward cross member 104. The support structures 118 and 119 each provide upwardly facing rider support surfaces 120 thereon.

A pair of engine mounting elements 121 (FIGS. 2 and 3) are attached to the lower member 102 between the forward cross member 103 and the rearward cross member 104. An engine 122 (FIGS. 3 and 4) is supported by the lower member 102 in the central opening 105 and a forward portion of the engine 122 is attached to the frame 100 through the engine mounting elements 121 by connectors 123 (FIG. 3).

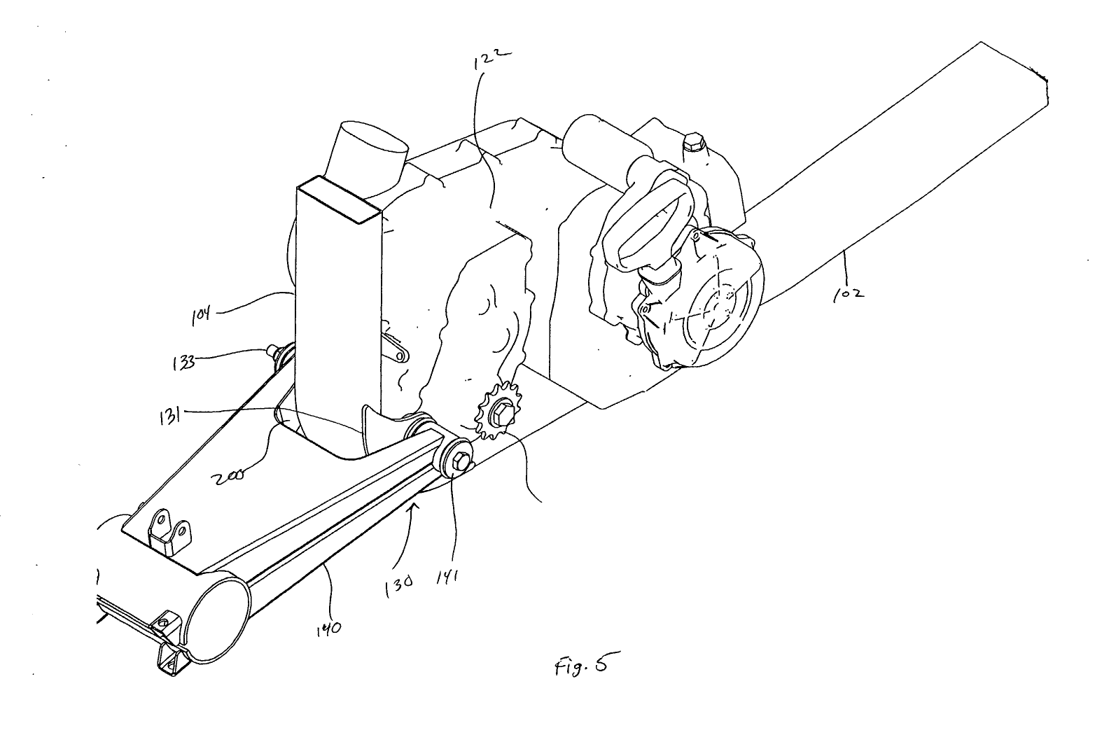

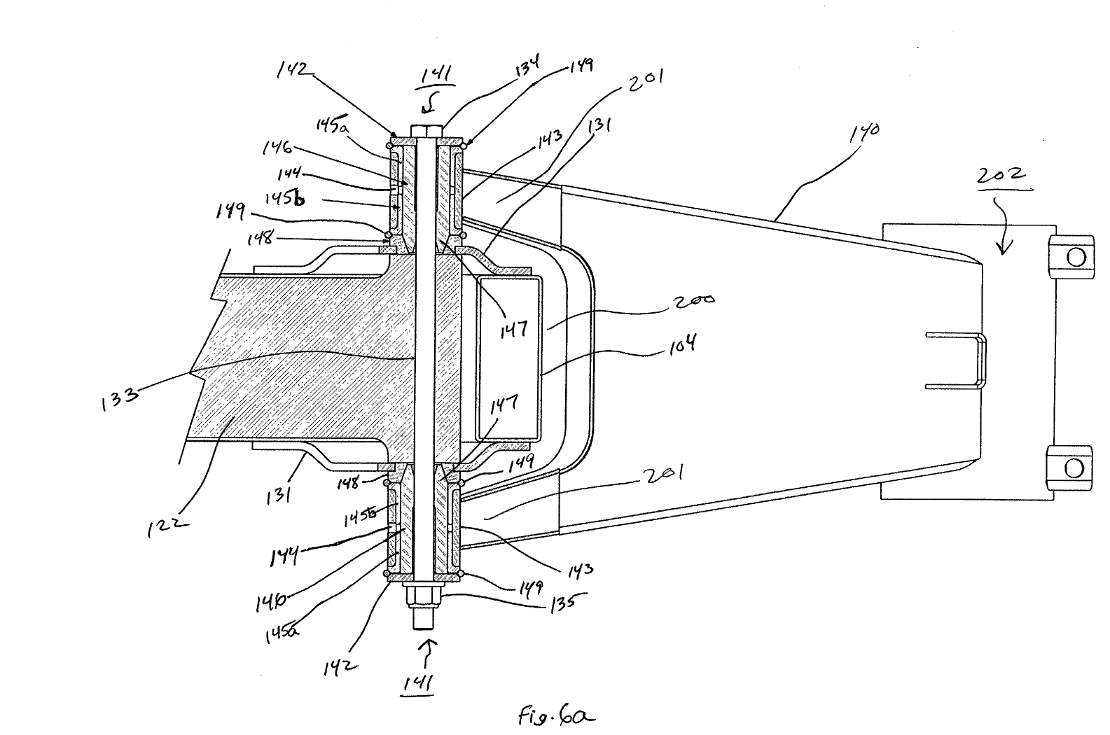

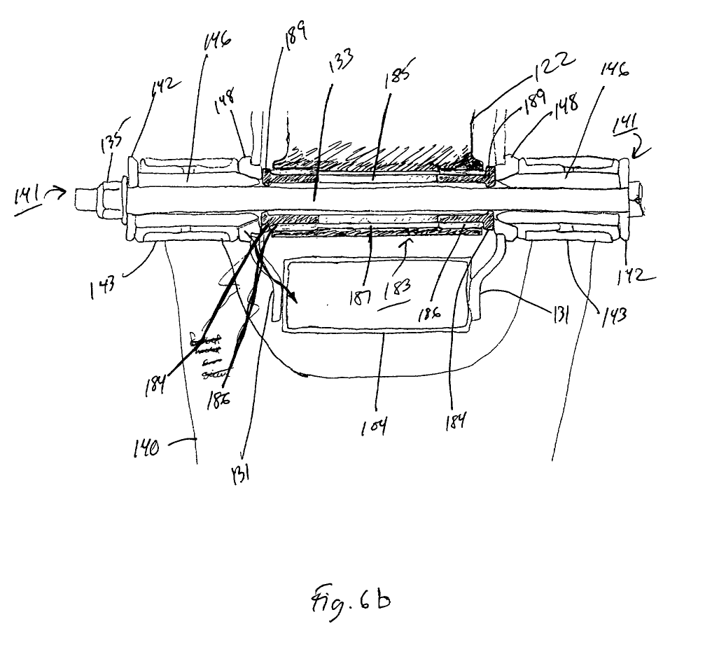

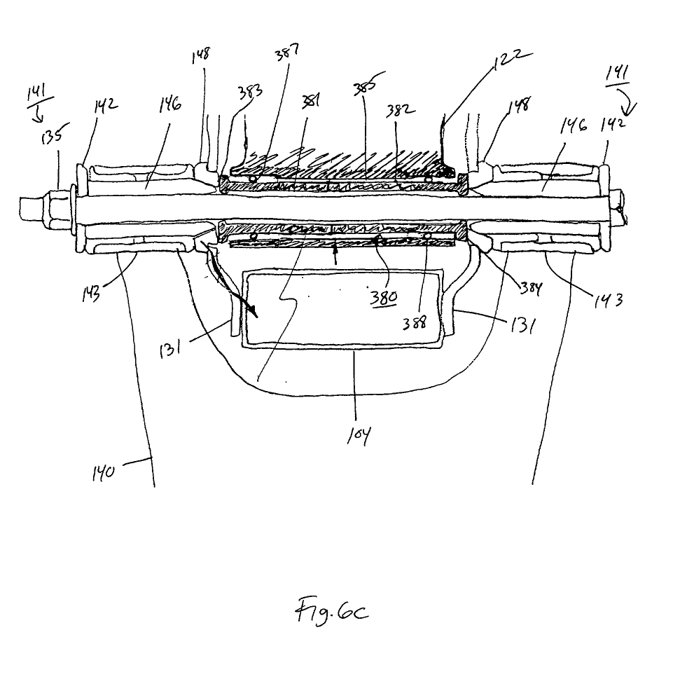

Referring to FIGS. 5 and 6a, an engine and swing arm connecting structure 130 is provided at the intersection of the lower member 102 and the rearward cross member 104. The connecting structure 130 includes a pair of webs 131 connected to the lower member 102 and the rearward cross member 104 by, for example, welding. As shown in FIG. 2, the webs 131 include apertures 132. A cylindrical transverse member 133 passes through the apertures 132, opposing journals 141 of a swing arm 140, and the engine 122, for example, through a portion of the engine casing, e.g., the crankcase of the engine 122. The transverse member 133 may be either a tube, a shaft or a rod.

The transverse member 133 has a head portion 134 at a first end that engages a thrust washer 142 disposed between the journal 141 and the head portion 134. A fastener element 135, such as a nut, is secured to the transverse member 133 at a second end and engages a thrust washer 142 disposed between the fastener element and a second journal 141.

Each journal 141 includes an outer sleeve 143 having an aperture 144. Each journal 141 also includes two bushings 145a and 145b formed of, for example, plastic that surround an inner sleeve 146 that includes a tapered end 147. The tapered end 147 of each inner sleeve 146 engages a tapered bushing 148 that is attached to the web 131 by, for example, welding. Seals 149, for example, O-rings, are provided at the engagement of the thrust washer 142 and the bushing 145a and at the engagement of the tapered bushing 148 and the bushing 145b.

As shown in FIGS. 5 and 6a, the swing arm 140 includes a frame member accommodating portion 200 that accommodates the rearward cross member 104 and at least a portion of the engine 122. The journals 141 are provided on bifurcated end portions 201 of the swing arm 140 laterally outside of the central opening 105 and the engine 122. The swing arm 140 has a generally tapered shape that increases in width from an axle support member 202 toward the bifurcated end portions 201. As both the journals 141 and the webs 131 are clamped on each side of the engine 122, coaxial integrity is maintained between the journals 141 and webs 131 and the bending and torsional stress transmitted to the frame 100 is reduced. As the load is transmitted directly through the engine 122 and the webs 131, the torsional and bending stress is less than conventional space frames that connect the swing arm laterally inside of the spaced frame members.

Referring to FIG. 2, the engine 122 is mounted at forward positions to the frame 100 at the engine mounting elements 121 by resilient coupling elements, such as rubber bushings (not shown). Referring to FIG. 6b, a dampener 183 is provided between the engine 122 and the swing arm 140. The dampener 183 includes two sleeves 184. Each sleeve 184 includes an end 189 in contact with each tapered bushing 148. The sleeves 184 may be formed of any metallic material. In a preferred embodiment, the sleeves 184 are formed of aluminum. A spacer 185 extends between the sleeves 184 and forces the sleeves 184 into contact with the bushings 148. A radial gap 187 is formed between an outer diameter of the spacer 185 and the engine 122. A rubber bushing 186 is molded around each sleeve 184. It should be appreciated that the rubber bushing 186 may be adhesively attached to the sleeve 184 or that the rubber bushing 186 may be press fit onto the sleeve 184. It should also be appreciated that an O-ring arrangement may be placed around the sleeves 184 instead of the rubber bushings 186. The rubber bushings 186 resiliently mount the engine 122 at rearward positions and dampen vibrations transmitted from the engine 122 to the frame 100 in a manner similar to the rubber bushings that mount the engine 122 at forward positions to the engine mounting elements 121. The rubber bushings 186 and the sleeves 184 reduce vibrations transmitted from the engine 122 to the frame 100 through the tapered bushings 148 and the webs 131.

Referring to FIG. 6c, a dampener 380 according to another embodiment includes two sleeves 381 and 382. The sleeves 381 and 382 may be formed of any metallic material. In a preferred embodiment, the sleeves 381 and 382 are formed of aluminum. The sleeves 381 and 382 include ends 383 and 384, respectively, in contact with the tapered bushings 148. The sleeves 381 and 382 reduce vibrations transmitted from the engine 122 to the frame 100 through the tapered bushings 148 and the webs 131.

A radial gap 385 is formed between outer diameters of the sleeves 381 and 382 and the engine 122. Each sleeve 381 and 382 has an O-ring arrangement 387 and 388, respectively, mounted around its outer diameter. It should be appreciated that a groove may be formed in the outer periphery of each sleeve 381 and 382 and each O-ring 387 and 388, respectively, may be located in a respective groove. It should also be appreciated that a plurality of O-rings may be mounted around the periphery of each sleeve 381 and 382 and that a plurality of grooves may be formed to locate each respective O-ring. The O-rings 387 and 388 reduce vibrations transmitted from the engine 122 to the frame 100 through sleeves 381 and 382, the tapered bushings 148, and the webs 131. The O-rings 387 and 388 resiliently mount the engine 122 at rearward positions and dampen vibrations transmitted from the engine 122 to the frame 100 in a manner similar to the rubber bushings that mount the engine 122 at forward positions to the engine mounting elements 121.

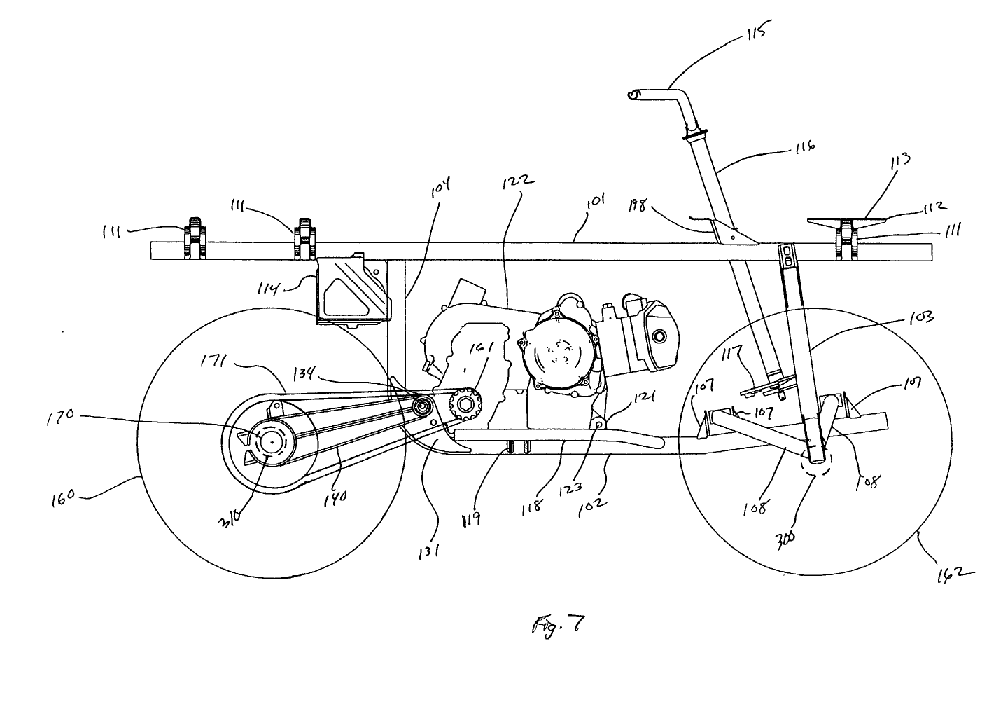

Referring to FIG. 7, the front suspension members 108 are operatively connected to front wheel assemblies 300 that rotatably support outboard wheels 162. The rear suspension system includes the swing arm 140 and a biasing member (not shown). The swing arm 140 is pivotably mounted to the frame 100 at the connecting structure 130. The biasing member is connected between the support module 114 and the swing arm 140 to bias movement of the swing arm 140 relative to the frame 100.

The swing arm 140 supports an axle 170 having outboard wheels 160 operatively connected to rear wheel assemblies 310 supported at the ends of the shaft member 170. The outboard wheels 160 are driven by a power transmission element 171, such as a chain or belt, that is driven by a drive member 161 of the engine 122.

Although the present invention has been described with reference to the exemplary embodiments outlined above, it should be appreciated that many modifications and alternatives will be readily apparent to those of ordinary skill in the art without departing from the spirit of the invention.

What is claimed is:

1. An all terrain vehicle, comprising:
a frame having a plurality of members defining a central opening;
an engine attached to the frame and disposed in the central opening; and
a swing arm pivotably attached to the frame and the engine.

2. An all terrain vehicle according to claim 1, wherein the swing arm includes two journals on a first end, the two journals being spaced on outwardly opposite sides of the central opening.

3. An all terrain vehicle according to claim 2, wherein each of the two journals includes an outer sleeve and an inner sleeve having a tapered end.

4. An all terrain vehicle according to claim 3, further comprising two webs, each of the two webs being attached to at least one of the frame members, and a tapered bushing connected to each web.

5. An all terrain vehicle according to claim 4, wherein each tapered bushing engages the tapered end of a corresponding inner sleeve.

6. An all terrain vehicle according to claim 4, wherein each of the two journals further includes first and second bushings between the inner and outer sleeves, wherein each of the two first bushings extends between the outer sleeve and the tapered bushing.

7. An all terrain vehicle according to claim 5, further comprising a seal at each engagement of each of the two tapered bushings and each of the two first bushings.

8. An all terrain vehicle according to claim 4, further comprising a transverse member extending through the engine, the webs and the journals.

9. An all terrain vehicle according to claim 7, further comprising a thrust washer disposed between each of the two journals and each end of the transverse member.

10. An all terrain vehicle according to claim 2, further comprising a transverse member that passes through the engine and the journals.

11. An all terrain vehicle according to claim 10, further comprising a thrust washer disposed between each of the two journals and each end of the transverse member.

12. A swing arm for supporting a shaft member of outboard wheel assemblies of an all terrain vehicle having a frame and an engine, the swing arm comprising:
a first end having two bifurcated end portions;
a journal provided at each bifurcated end portion; and
a second end having an axle support member, wherein the swing arm is tapered such that the first end has a greater width than the second end.

13. A swing arm according to claim 12, wherein each journal includes an outer sleeve, an inner sleeve, and at least one bushing between each inner sleeve and each outer sleeve.

14. An all terrain vehicle having a plurality of wheels, the all terrain vehicle comprising:
a frame having a plurality of members defining a central opening;
an engine disposed in the central opening, the engine providing power to at least one of the plurality of wheels; and
a swing arm having a first end including two end portions with a space therebetween, and a second end including an axle support member, at least a portion of the frame being disposed in the space between the two end portions.

15. An all terrain vehicle according to claim 14, wherein the two end portions are attached to the engine.

16. An all terrain vehicle according to claim 14, wherein the two end portions are attached to the frame.

17. An all terrain vehicle according to claim 14, wherein the two end portions are connected to the frame and the engine.

18. An all terrain vehicle according to claim 14, wherein a transverse member connects the two end portions.

19. An all terrain vehicle according to claim 18, wherein the transverse member is connected to the engine.

20. An all terrain vehicle according to claim 18, wherein the transverse member is connected to the frame.

21. An all terrain vehicle according to claim 18, wherein the transverse member is connected to the engine and the frame.

22. An all terrain vehicle according to claim 14, wherein a width of the frame is less than a width of the swing arm.

23. A swing arm for an all terrain vehicle having a frame and an engine, the swing arm comprising:
a first end including two end portions with a space therebetween; and
a second end including an axle support member, at least a portion of the frame being disposable in the space between the two end portions.

24. A swing arm according to claim 23, wherein the two end portions are connectable to the engine.

25. A swing arm according to claim 23, wherein the two end portions are connectable to the frame.

26. A swing arm according to claim 23, wherein the two end portions are connectable to the frame and the engine.

27. A swing arm according to claim 23, wherein a transverse member connects the two end portions.

28. A swing arm according to claim 27, wherein the transverse member is connectable to the engine.

29. A swing arm according to claim 27, wherein the transverse member is connectable to the frame.

30. A swing arm according to claim 27, wherein the transverse member is connectable to the frame and the engine.

31. An all terrain vehicle having a plurality of wheels, the all terrain vehicle comprising:
a frame having a plurality of members defining a central opening;
an engine disposed in the central opening, the engine providing power to at least one of the plurality of wheels; and
a swing arm having a first end including two end portions with a space therebetween, and a second end including an axle support member, at least a portion of the engine being disposed in the space between the two end portions.

32. A swing arm for an all terrain vehicle having a frame and an engine, the swing arm comprising:
a first end including two end portions with a space therebetween; and
a second end including an axle support member, at least a portion of the engine being disposable in the space between the two end portions.

33. An all terrain vehicle according to claim 1, further comprising a dampener between the engine and the swing arm that reduces transmission of vibrations from the engine to the frame.

34. An all terrain vehicle according to claim 33, wherein the dampener comprises at least two sleeves disposed within a portion of the engine.

35. An all terrain vehicle according to claim 34, wherein the dampener further comprises a spacer that extends between the at least two sleeves.

36. An all terrain vehicle according to claim 34, wherein the dampener further comprises a rubber bushing between each of the two sleeves and the portion of the engine.

37. An all terrain vehicle according to claim 34, wherein the dampener further comprises at least one O-ring between each of the two sleeves and the portion of the engine.
